(19) United States
(12) Patent Application Publication
(10) Pub. No.: US 2026/0337838 A1
(43) Pub. Date: Oct. 29, 2026

(54) COMPOSITE FABRIC STRUCTURE, BOWKNOT MADE OF COMPOSITE FABRIC STRUCTURE, AND METHOD FOR MAKING BOWKNOT

(71) Applicant: Guangzhou Guangmian Technology Co., Ltd., Guangzhou (CN)

(72) Inventor: Wanfa Liang, Guangzhou (CN)

(21) Appl. No.: 19/211,838

(22) Filed: May 19, 2025

(30) Foreign Application Priority Data
Apr. 29, 2025 (CN) 202520841936.0

(51) Int. Cl. D04D 7/10; B32B 5/02; B32B 5/26

(52) U.S. Cl. CPC D04D 7/105; B32B 5/02; B32B 5/022; B32B 5/265; B32B 2250/20; B32B 2262/14; B32B 2307/21; B32B 2307/7376; B32B 2451/00

(57) ABSTRACT

Disclosed in the present disclosure are a composite fabric structure, a bowknot made of a composite fabric structure, and a method for making a bowknot. The composite fabric structure includes a nonwoven fabric and anti-static flannelette. The bowknot is made of the composite fabric structure, is not prone to collapse and deformation, is anti-static, capable of preventing dust adsorption, and easy to clean and maintain. A core body of the bowknot is the nonwoven fabric, such that folding can be achieved, and packing and transportation are convenient.

### CROSS-REFERENCE TO RELATED APPLICATIONS

This application claims priority to Chinese Patent Application No. 202520841936.0, filed on Apr. 29, 2025, which is hereby incorporated by reference in its entirety.

### TECHNICAL FIELD

The present disclosure relates to the field of making of decorations, and in particular to a composite fabric structure, a bowknot made of a composite fabric structure, and a method for making a bowknot

### BACKGROUND

A bowknot decoration current on the market is made of single fabric or a common composite material, which is faced with the following technical problems: 1. A traditional bowknot is made of a foam material, and for a bowknot with a larger size, the bowknot is not stiff enough and is prone to collapse or deformation. 2. In a long-term placement process, the bowknot is likely to be electrostatic, and dust is likely to be adsorbed, which is not conducive to maintenance. 3. Most of traditional bowknots are fixed by using a sewing technology, such that a production process is increased, and the bowknots that are integrally sewed are inconvenient to transport.

In view of the above, the present disclosure provides a composite fabric structure, a bowknot made of a composite fabric structure, and a method for making a bowknot, so as to solve the above problems.

### SUMMARY

In order to overcome the technical defects, the present disclosure provides a composite fabric structure, which can support rigid support, not prone to collapse or deformation, and has an anti-statistic property.

To achieve the above objective, the present disclosure employs the following technical solutions:

A composite fabric structure, including a nonwoven fabric, where one surface or two surfaces of the nonwoven fabric are provided with flannelette, the flannelette includes an anti-static base layer, one surface of the anti-static base layer is provided with a first adhesive layer for being connected to the nonwoven fabric, and fluff is attached to the other surface of the anti-static base layer.

Preferably, the anti-static base layer is in a composite structure formed by blending conductive fibers and ordinary fibers.

Preferably, a thickness of the nonwoven fabric is 0.5-5 mm, a thickness of the flannelette is 0.5-5 mm, and the thickness of the nonwoven fabric is greater than that of the flannelette.

In order to overcome the technical defects, the present disclosure further provides a bowknot, which is made of a composite material and is not prone to collapse or deformation.

The bowknot includes a cloth cover with creases, and the cloth cover is a composite material. The bowknot further includes a binding band, where the binding band is used for binding a center of the cloth cover and enabling the cloth cover to form a wing-like structure with two symmetrical sides relative to the binding band, and a decoration ring is wrapped round the binding band.

Preferably, a transverse width of the cloth cover is greater than 75 cm.

Preferably, the bowknot further includes tail bands, and tops of the tail bands are connected to the decoration ring.

Preferably, the top of the tail band is provided with a second adhesive layer for being connected to the decoration ring, and a surface of the second adhesive layer is coated with release paper.

Preferably, the tail band is in a composite fabric structure.

In order to overcome the technical defects, the present disclosure further provides a method for making a bowknot, and the steps are simple.

The method for making a bowknot, including the following steps:
step 1. making a composite fabric structure: sticking flannelette on one surface or two surfaces of a nonwoven fabric;
step 2. making a cloth sheet for forming the bowknot: cutting the composite fabric structure into a rectangular cloth cover, strip-shaped tail bands and a strip-shaped decoration band;
step 3. making the bowknot: folding the cloth cover multiple times in a transverse direction to form multiple transverse creases, where a side surface of the cloth cover after folding is in a wave shape; then, longitudinally folding the cloth cover in half to form a longitudinal crease; binding a binding band at the longitudinal crease, and trimming a redundant portion of the binding band; enabling the decoration band to encircle an outer portion of the binding band, then, connecting two ends of the decoration band with glue or a staple to form a decoration ring, and enabling the cloth cover to form a wing-like structure with two symmetrical sides relative to the binding band; enabling connection positions of the two ends of the decoration band to be positioned at a back of the cloth cover; arranging double-sided adhesive tapes at tops of the tail bands; and
step 4. packing the bowknot.

Preferably, step 4 includes: rolling up the tail bands and fixing same with the binding band; folding the cloth cover in the wing-like structure on two sides of the decoration ring in half, since the decoration ring have a certain width, forming a gap between two portions of the cloth cover in the wing-like structure after folding, and placing the rolled up tail bands in the gap to reduce space occupied by the bowknot; and then, putting the whole bowknot into a packing bag or a packing box.

Preferably, making of the flannelette includes the following steps: blending conductive fibers, ordinary fibers and pile warp to form an anti-static base layer, performing pile cutting treatment on one surface of the anti-static base layer to form fluff, and coating a first adhesive layer on the other surface of the anti-static base layer.

Compared with the prior art, the present disclosure has the beneficial effects as follows:
1. The nonwoven fabric can improve the overall stiffness of the composite fabric structure and avoid collapse and deformation. Moreover, the nonwoven fabric has a rough surface, which is conductive to firm connection to the first adhesive layer. The flannelette of the composite fabric structure can be anti-static, and can reduce the adsorption situation of dust and fine particles due to an electrostatic effect, thereby reducing cleaning work of the composite fabric structure.
2. The bowknot of the present disclosure has a larger size, which is made of the composite fabric structure, is not prone to collapse and deformation, is anti-static, capable of preventing dust adsorption, and easy to clean and maintain. A core body of the bowknot is the nonwoven fabric, such that folding can be achieved, and packing and transportation are convenient.
3. When the bowknot is made, the wing-like structure with two symmetrical sides relative to the binding band is formed by binding the binding band at the center of the cloth cover, the tail bands are provided with the second adhesive layers for being connected to the decoration ring, and no sewing is needed, such that the making cost is reduced, and market competitiveness is improved.
4. According to the present disclosure, the cloth cover is folded and bound to form the cloth cover in the wing-like structure, then, the cloth cover in the wing-like structure on two sides of the decoration ring is folded in half, and the rolled up tail bands are placed in the gap, such that the space occupied by the bowknot is effectively reduced. This packing method makes the bowknot more compact during transportation and storage, which reduces the transportation cost and storage space requirements. Moreover, when a user uses the bowknot, the user only needs to stick the tail bands and the decoration ring, which is simple to operate.

### BRIEF DESCRIPTION OF THE DRAWINGS

FIG. 1 is a schematic structural diagram of a composite fabric structure of the present disclosure.

FIG. 2 is a schematic diagram of a cloth sheet for forming a bowknot of the present disclosure.

FIG. 3 is a schematic diagram of a cloth cover with creases of the present disclosure.

FIG. 4 is a schematic diagram of a cloth cover in a wing-like structure of the present disclosure.

FIG. 5 is a schematic diagram of a bowknot of the present disclosure.

FIG. 6 is a schematic diagram of a finished bowknot of the present disclosure.

FIG. 7 is a schematic diagram for packing a cloth cover in a wing-like structure of the present disclosure.

An implementation of the objective, functional characteristics and advantages of the present disclosure will be further described with reference to the accompanying drawings and in combination with the examples.

### DETAILED DESCRIPTIONS OF THE EMBODIMENTS

The features of the present disclosure and other related features are described in further detail below through examples to facilitate understanding by those skilled in the art:

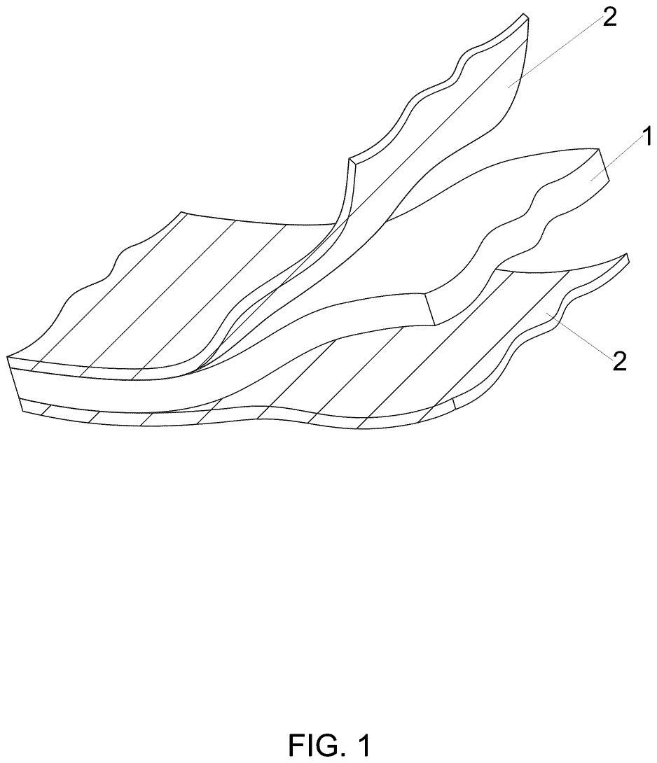

Referring to FIG. 1, a first example of the present disclosure provide a composite fabric structure, including a nonwoven fabric 1, where two surfaces of the nonwoven fabric 1 are provided with flannelette 2, the flannelette 2 includes an anti-static base layer, one surface of the anti-static base layer is provided with a first adhesive layer (not shown in the figure) for being connected to the nonwoven fabric 1, and fluff (not shown in the figure) is attached to the other surface of the anti-static base layer. The fluff can make the flannelette 2 have a visual velvety luster.

The anti-static base layer is a fabric formed by blending conductive fibers and ordinary fibers. The conductive fibers are composite fibers doped with carbon nanotubes, graphene, silver and copper. The anti-static base layer can quickly conduct frictional charge on the fluff, and avoid adsorption of dust and fine particles due to accumulation of static charge, thus reducing cleaning work of the composite fabric structure. In Example 1, the anti-static base layer has a surface resistance being ≤10⁹ Ω/sq.

Specifically, a thickness of the nonwoven fabric 1 is 0.5-5 mm, a thickness of the flannelette 2 is 0.5-5 mm, and the thickness of the nonwoven fabric 1 is greater than that of the flannelette 2. A gram weight of the nonwoven fabric 1 is 150-400 g/m², and the nonwoven fabric 1 can improve the overall stiffness of the composite fabric structure and avoid collapse and deformation.

In the present disclosure, the first adhesive layer is a hot melt adhesive coating. The nonwoven fabric 1 has a rough surface, which is conductive to firm connection to the first adhesive layer.

A second example of the present disclosure provides a composite fabric structure, including a nonwoven fabric, where one surface of the nonwoven fabric is provided with flannelette, and other structures are the same as those in the first example.

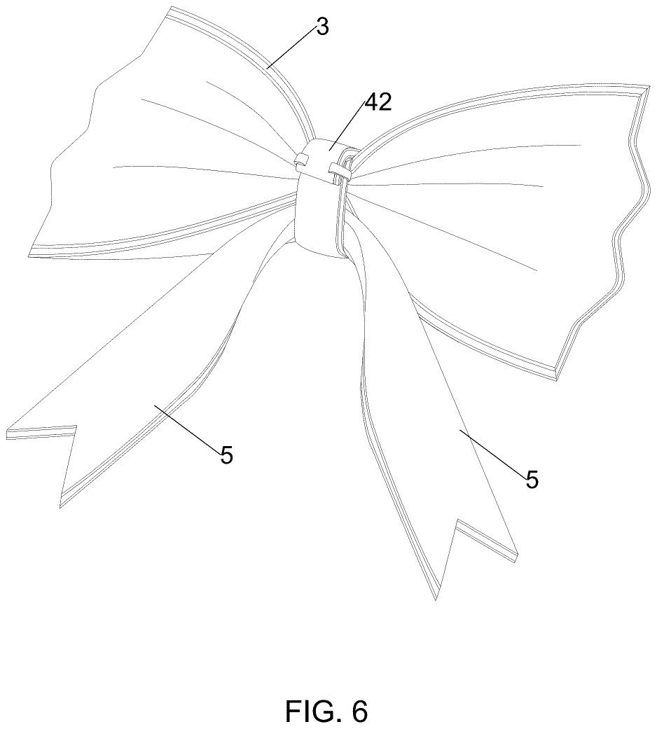

Referring to FIGS. 1-6, a third example of the present disclosure provides a bowknot, including a cloth cover 3 with creases and a binding band 6, where the binding band 6 is used for binding a center of the cloth cover 3 and enabling the cloth cover 3 to form a wing-like structure with two symmetrical sides relative to the binding band 6, and a decoration ring 4 is wrapped round the binding band 6 for covering the binding band 6, such that the bowknot looks more beautiful. Specifically, the decoration ring 4 is a band-shaped fabric, and after the decoration ring is wrapped round the binding band 6, two ends of the band-shaped fabric are connected through a staple 41, a magic sticker or a hot melt adhesive.

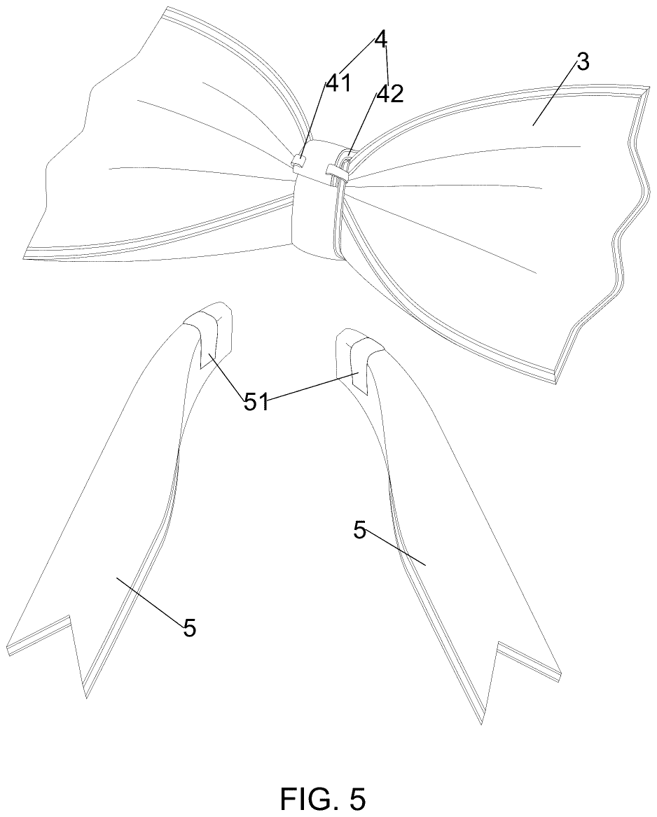

As shown in FIG. 5, the bowknot further includes two tail bands 5. The top of the tail band 5 is provided with a second adhesive layer for being connected to the decoration ring, and a surface of the second adhesive layer is coated with release paper. Specifically, when the bowknot needs to be assembled, the release paper is torn off, and the tops of the tail bands 5 are connected to an inner wall or a back of the decoration ring 4.

For the whole bowknot, sewing is not needed, such that the making cost is reduced, and market competitiveness is improved.

Specifically, the cloth cover 3, the tail bands 5 and the decoration ring 4 are in the composite fabric structure in the first example, and the composite fabric structure takes the nonwoven fabric 1 as a core body and can be folded. Compared with a bowknot made of a foam material in the prior art, the composite fabric structure of the present disclosure does not leave obvious creases after being folded and unfolded, such that the cloth cover 3 of the bowknot is folded and packed, and the tail bands 5 are rolled up and then fixed by the binding band, thereby reducing space occupied during packing and transportation, and facilitating the transportation.

A transverse width of the cloth cover 3 is greater than 75 cm, and since the cloth cover 3 takes the nonwoven fabric 1 as the core body, the nonwoven fabric 1 improves the overall stiffness of the composite fabric structure, such that the bowknot is not prone to collapse or deformation. Moreover, a surface of the flannelette 2 is anti-static and prevent adsorption of dust, such that the bowknot is easy to clean and maintain.

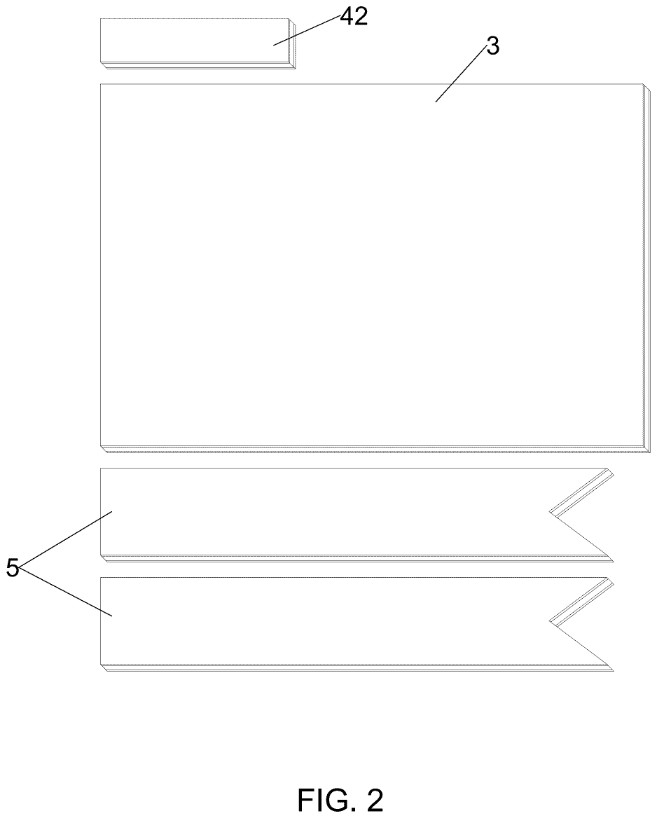

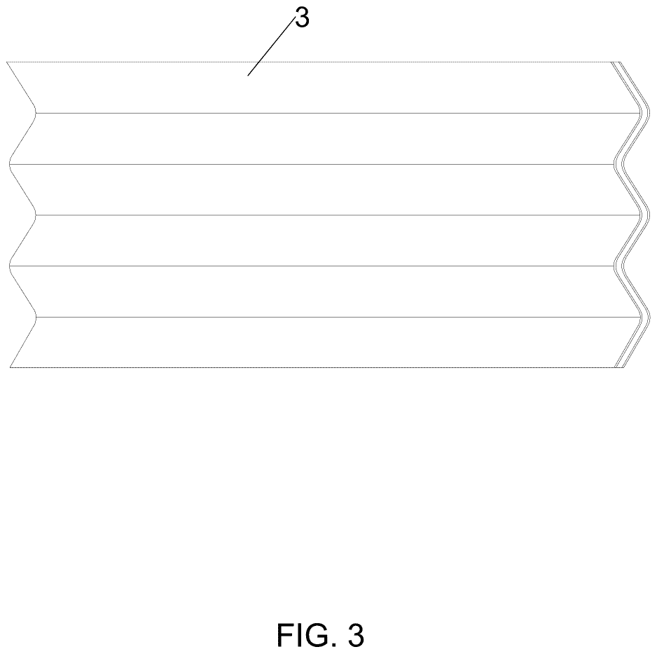

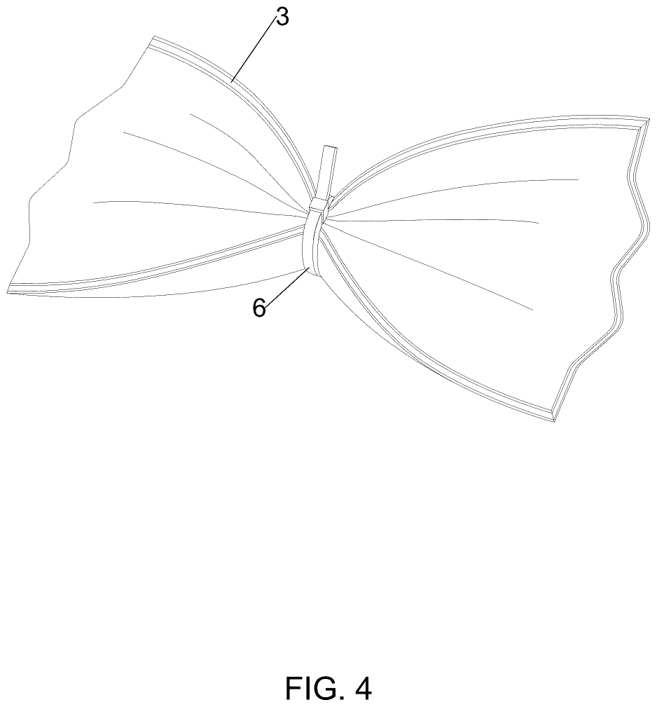

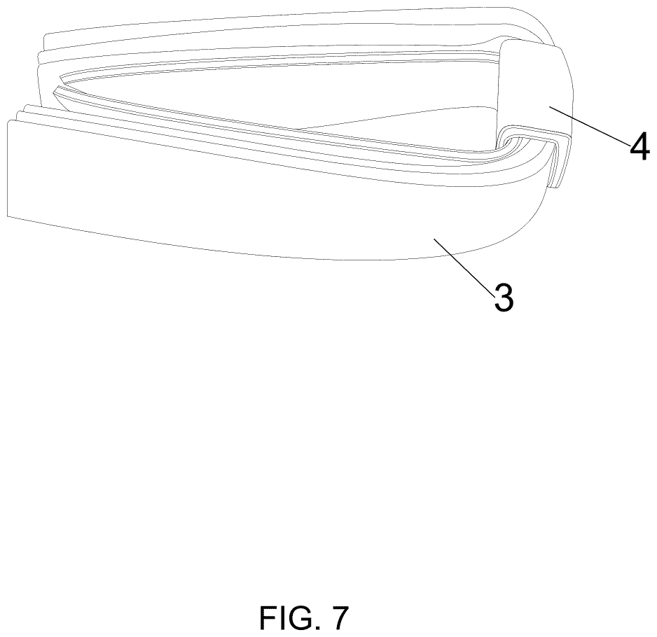

Referring to FIGS. 1-7, a fourth example of the present disclosure provides a method for making a bowknot, including the following steps:
Step 1. A composite fabric structure is made: flannelette is stuck on one surface or two surfaces of a nonwoven fabric.
Step 2. A cloth sheet for forming the bowknot is made: as shown in FIG. 2, the composite fabric structure is cut into a rectangular cloth cover 3, strip-shaped tail bands 5 and a strip-shaped decoration band 42, and a transverse width of the cloth cover 3 is greater than 75 cm.
Step 3. The bowknot is made: as shown in FIG. 3, the cloth cover 3 is folded multiple times in a transverse direction to form multiple transverse creases, where a side surface of the cloth cover 3 after folding is in a wave shape. As shown in FIG. 4, then, the cloth cover is longitudinally folded in half to form a longitudinal crease. A binding band 6 is bound at the longitudinal crease, and a redundant portion of the binding band 6 is trimmed. The decoration band 42 is enabled to encircle an outer portion of the binding band 6, then, two ends of the decoration band 42 are connected with glue or a staple 41 to form a decoration ring 4. The cloth cover 3 is enabled to form a wing-like structure with two symmetrical sides relative to the binding band 6. Connection positions of the two ends of the decoration band 42 are enabled to be positioned at a back of the cloth cover 3, and the back of the cloth cover 3 refers to a surface, back to a sight line of a user, of the bowknot. Double-sided adhesive tapes 51 are arranged at tops of the tail bands 5.
Step 4. The bowknot is packed: the tail bands 5 are rolled up and fixed with the binding band. As shown in FIG. 7, the cloth cover 3 in the wing-like structure on two sides of the decoration ring are folded in half, since the decoration ring 4 has a certain width, a gap is formed between two portions of the cloth cover 3 in the wing-like structure after folding, and the rolled up tail bands 5 are placed in the gap. Then, the whole bowknot is put into a packing bag or a packing box.

As shown in FIG. 5, in the present disclosure, the bowknot is made of the cloth cover 3. When the user uses the bowknot, the user only needs to stick the tail bands 5 and the decoration ring, which is simple to operate. Moreover, the cloth cover 3 in the wing-like structure of the bowknot can be further folded relative to the decoration ring, and then, by optimizing placement positions of the rolled up tail bands 5 and the folded cloth cover 3 in the wing-like structure, such that the space occupied by the bowknot can be saved, and the transportation cost and storage space requirements are reduced.

Specifically, making of the flannelette includes the following steps: conductive fibers, ordinary fibers and pile warp are blended to form an anti-static base layer, pile cutting treatment is performed on one surface of the anti-static base layer to form fluff, and a first adhesive layer is coated on the other surface of the anti-static base layer.

Specifically, in step 1, the surface, coated with the first adhesive layer, of the flannelette is stuck on the nonwoven fabric, and pressing is performed by a hot press at 100-130° C. under 0.3-0.6 MPa for 30-60 seconds.

What is described above are only preferred examples of the present disclosure and do not limit the patent scope of the present disclosure, and equivalent structure change made by using the accompanying drawing contents of the description in the present disclosure and used directly or indirectly in other related technical fields shall all fall within the patent scope of protection of the present disclosure in a similar way.

What is claimed is:

1. A composite fabric structure, comprising a nonwoven fabric, wherein one surface or two surfaces of the nonwoven fabric are provided with flannelette, the flannelette comprises an anti-static base layer, one surface of the anti-static base layer is provided with a first adhesive layer for being connected to the nonwoven fabric, and fluff is attached to the other surface of the anti-static base layer.

2. The composite fabric structure according to claim 1, wherein the anti-static base layer is in a composite structure formed by blending conductive fibers and ordinary fibers.

3. The composite fabric structure according to claim 1, wherein a thickness of the nonwoven fabric is 0.5-5 mm, a thickness of the flannelette is 0.5-5 mm, and the thickness of the nonwoven fabric is greater than that of the flannelette.

4. A bowknot, comprising a cloth cover with creases and tail bands, wherein the cloth cover and the tail bands are in the composite fabric structure according to claim 1; and the bowknot further comprises a binding band, wherein the binding band is used for binding a center of the cloth cover and enabling the cloth cover to form a wing-like structure with two symmetrical sides relative to the binding band, a decoration ring is wrapped round the binding band, and tops of the tail bands are connected to the decoration ring.

5. The bowknot according to claim 4, wherein a transverse width of the cloth cover before binding is greater than 75 cm.

6. The bowknot according to claim 4, wherein the top of the tail band is provided with a second adhesive layer for being connected to the decoration ring, and a surface of the second adhesive layer is coated with release paper.

7. A method for making the bowknot according to claim 4, comprising the following steps:
step 1. making a composite fabric structure: sticking flannelette on one surface or two surfaces of a nonwoven fabric;
step 2. making a cloth sheet for forming the bowknot: cutting the composite fabric structure into a rectangular cloth cover, strip-shaped tail bands and a strip-shaped decoration band;
step 3. making the bowknot: folding the cloth cover multiple times in a transverse direction to form multiple transverse creases, wherein a side surface of the cloth cover after folding is in a wave shape; then, longitudinally folding the cloth cover in half to form a longitudinal crease; binding a binding band at the longitudinal crease, and trimming a redundant portion of the binding band; enabling the decoration band to encircle an outer portion of the binding band, then, connecting two ends of the decoration band with glue or a staple to form a decoration ring, and enabling the cloth cover to form a wing-like structure with two symmetrical sides relative to the binding band; enabling connection positions of the two ends of the decoration band to be positioned at a back of the cloth cover; arranging double-sided adhesive tapes at tops of the tail bands; and
step 4. packing the bowknot.

8. The method for making the bowknot according to claim 7, wherein the step 4 comprises:
rolling up the tail bands and fixing same with the binding band; folding of the cloth cover in the wing-like structure on two sides of the decoration ring in half, since the decoration ring has a certain width, forming a gap between two portions of the cloth cover in the wing-like structure after folding, and placing the rolled up tail bands in the gap to reduce space occupied by the bowknot; and then, putting the whole bowknot into a packing bag or a packing box.

9. The method for making the bowknot according to claim 7, wherein making of the flannelette comprises the following steps: blending conductive fibers, ordinary fibers and pile warp to form an anti-static base layer, performing pile cutting treatment on one surface of the anti-static base layer to form fluff, and coating a first adhesive layer on the other surface of the anti-static base layer.
